(19) United States
(12) Patent Application Publication
(10) Pub. No.: US 2010/0093878 A1
(43) Pub. Date: Apr. 15, 2010

(54) CROSSLINKABLE FLUOROPOLYMER, CROSSLINKED FLUOROPOLYMERS AND CROSSLINKED FLUOROPOLYMER MEMBRANES

(75) Inventors: ZHEN-YU YANG, Hockessin, DE (US); Amy Qi Han, (US); Mark Gerrit Roelofs, Hockessin, DE (US); Randal L. Perry, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/344,768

(22) Filed: Dec. 29, 2008

Related U.S. Application Data
(60) Provisional application No. 61/016,956, filed on Dec. 27, 2007.

(51) Int. Cl. C08J 5/20; C08F 28/02; C08F 214/18; C08F 24/00; B05D 5/12

(52) U.S. Cl. 521/27; 526/286; 526/254; 526/270; 427/115

(57) ABSTRACT

Crosslinkable fluoropolymers and crosslinked fluoropolymers prepared from select fluorinated monomers by dimerization and trimerization. Also disclosed are proton conductive membranes of these crosslinked fluoropolymers.

### FIELD

Disclosed are crosslinkable fluoropolymers and crosslinked fluoropolymers. Also disclosed are proton conductive membranes of these crosslinked fluoropolymers.

### BACKGROUND

It has long been known in the art to form ionically conducting polymer electrolyte membranes and gels from organic polymers containing ionic pendant groups. Well-known so-called ionomer membranes in widespread commercial use are Nafion® perfluoroionomer membranes available from E.I. du Pont de Nemours and Company, Wilmington, Del. Nafion® is formed by copolymerizing tetrafluoroethylene (TFE) with perfluoro (3,6-dioxa-4-methyl-7-octenesulfonyl fluoride), as disclosed in U.S. Pat. No. 3,282,875. Other well-known perfluoroionomer membranes are composed of copolymers of TFE with perfluoro (3-oxa-4-pentene sulfonyl fluoride), as disclosed in U.S. Pat. No. 4,358,545. The copolymers so formed are converted to the ionomeric form by hydrolysis, typically by exposure to an appropriate aqueous base, as disclosed in U.S. Pat. No. 3,282,875. Lithium, sodium and potassium are all well known in the art as suitable cations for the above cited ionomers.

It is known that membrane conductivity can be improved by reducing the equivalent weight of the polymer comprising the membrane. However, reducing equivalent weight to obtain high conductivity gives rise to problems with poor mechanical properties in proton conductive membranes. One approach to improve mechanical properties is to prepare crosslinked ionomers. Crosslinked terpolymers of TFE, perfluorovinyl ethers containing sulfonyl fluoride, and fluorinated dienes are disclosed in European patent EP 1172382. Various crosslinkers are disclosed in European patent EP 1167400 and U.S. Pat. Nos. 6,214,955 and 6,255,543 disclose polymers containing cyclic repeating units of from selected partially fluorinated monomers.

What is needed, are new crosslinked polymers that can be formed into conductive proton conductive membranes with good mechanical properties.

### SUMMARY

Disclosed herein is a crosslinkable polymer as shown in the following formula:

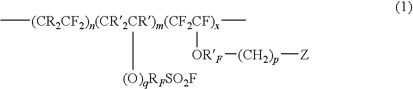

wherein R_{F} and R′_{F} are independently linear or branched perfluoroalkylene groups of 1 to 20 carbon atoms, optionally containing oxygen or chlorine;
p and q are independently integers from 0 to 1;
R and R′ are independently H or F with the proviso that when R′ is F then q is 1;
n, m, and x are the number of repeating units of the monomers; and
Z is selected from SO₂N₃, OCN and CN.

Also disclosed is a crosslinked polymer of formula (1), formed by the cleavage reactions of Z moiety to form the crosslinked polymer.

Also disclosed are hydrolyzed crosslinkable polymers containing —R_{F}SO₃M groups formed by the hydrolysis of —R_{F}SO₂F groups of the crosslinkable polymers of formula (1); where M is independently H, an alkali cation, ammonium or substituted ammonium groups, as shown in the formula:

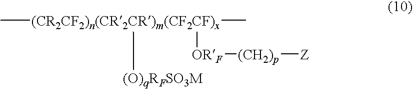

wherein R_{F} and R′_{F} are independently linear or branched perfluoroalkyl groups of 1 to 20 carbon atoms, optionally containing oxygen or chlorine;
p and q are independently integers from 0 to 1;
R and R′ are independently H or F, with the proviso that when R′ is F then q is 1;
n, m, and x are the number of repeating units of the monomers;
Z is selected from SO₂N₃, OCN and CN; and

M is independently H, an alkali cation, ammonium or substituted ammonium groups.

Also disclosed is a crosslinked polymer formed by the cleavage reactions of Z moiety of the crosslinkable polymer of formula (10), to form the crosslinks.

Also disclosed are ion- and proton-conductive membranes containing —R_{F}SO₃M groups formed by the hydrolysis of —R_{F}SO₂F groups of the crosslinked polymers formed by crosslinking of the crosslinkable polymers of formula (1) and (10); wherein M is independently H, an alkali cation, ammonium or substituted ammonium groups.

Also disclosed is an electrochemical cell comprising the ion- and proton-conductive membrane.

Also disclosed are processes to prepare the crosslinkable polymers of formula (1) and their hydrolyzed crosslinked polymers. Also disclosed are processes to prepare proton conductive membranes from the crosslinkable polymers.

Although not wishing to be bound by theory, it is believed that the crosslinks form via cleavage reactions of the pendant Z moieties. Such cleavage of the crosslinking agent provide for increased chain lengths between crosslinks and gives rise to the required mechanical properties.

### DETAILED DESCRIPTION

Disclosed herein are crosslinkable polymers and their crosslinked polymers that are useful in making proton-conductive membranes for electrochemical cells such as fuel cells and can be used in any application wherein ion conductive capacity is desired. The crosslinked polymers may be used as acid catalysts with low swelling. The ion conductive membranes may also be used as electrolytes, electrode binders, sensors, electrolysis cells, in lithium batteries in lithium salt form, and in any application requiring charge-transfer phenomena, such as components of light-emitting displays. The crosslinkable polymers described herein can be interpolymers.

As defined herein “alkyl” it is meant a monovalent group containing only carbon and hydrogen, chiral or achiral, connected by single bonds and/or by ether linkages, and substituted accordingly with hydrogen atoms. It can be independently linear, branched, or cyclic.

As defined herein “alkylene” it is meant a divalent alkyl group.

As defined herein “optionally fluorinated” it is meant that one or more of the hydrogens can be replaced with fluorines.

As defined herein the term “interpolymer” is intended to include oligomers and polymers having different repeating units. The term “copolymer” means polymers having two or more different repeating units. The term “terpolymer” means polymers having three or more different repeating units. The term “tetrapolymer” is intended to include oligomers and copolymers having four or more different repeating units. A tetrapolymer derived from monomers A, B, C and D has repeating units (-A-), (-B-), (-C-) and (-D-). The interpolymers described herein can have repeating units distributed in a random or block manner.

As defined herein “crosslinking” is the attachment of a polymer chain with another or the same chain. In general high crosslinking results in insolubility in a particular solvent. The selection of polymer molecular weight, polymer and copolymer composition, and a solvent is within the purview of one skilled in the art. As the total number of crosslinks increase the molecular weight of the polymer increases. The increase in molecular weight is generally expected to result in a reduced solubility of the polymer in a particular solvent. The amount of crosslinking is can be adjusted by the selection of the amount of crosslinkable monomer containing the crosslinkable moiety. Crosslinking may be initiated by heating. The crosslinking may also be initiated by, ultraviolet radiation, gamma ray radiation, electron beam radiation and heavy ion radiation resulting to cause the formation of crosslinks. A combination of heating and radiation can also be used to cause crosslinking.

As defined herein “dimerization” includes “trimerization” and higher order reactions up to “pentamerization”. For example dimerization reactions involve intermediates such as polymer chains, oligomers, or monomers. As an example polymer chains containing the —SO₂N₃ can form crosslinks by cleavage of the —SO₂N₃ to release SO₂ and N₂.

As defined herein the term “membrane”, a term of art in common use in electrochemistry, is synonymous with the terms “film” or “sheet”, which are terms of art in more general usage, but refer to the same articles. The term “membrane” can include proton conductive membranes and may or may not be crosslinked.

Disclosed are crosslinkable polymers containing the repeating units (CR₂CF₂)ₙ, (CR′₂CR′(O)_{q}R_{F}SO₂F)ₘ, and (CF₂CFOR′_{F}—(CH₂)ₚ—Z)ₓ. Such crosslinkable polymers are shown below in formula (1):

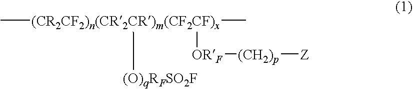

wherein R_{F} and R′_{F} are independently linear or branched perfluoroalkylene groups of 1 to 20 carbon atoms, optionally containing oxygen or chlorine;
p and q are independently integers from 0 to 1;
R and R′ are independently H or F, with the proviso that when R′ is F then q is 1;
n, m, and x are the number of repeating units of the monomers; and
Z is selected from SO₂N₃, OCN and CN.

The number of repeating units n, m and x can have values that are fractions. The ranges of the numbers are: n from about 70-95 mol %; preferably 80-85 mol %; m from about 10-30 mol %; preferably from about 12-18 mol %; x from about 1-8 mol %, preferably from about 2-3 mol %. In an embodiment n is 80 mol %, m is 16 mol %, and x is 4 mol %.

In one embodiment, R′ is F and q=1. In one embodiment R′ is H and q=0. In further embodiments, R_{F} and R′_{F} be independently —CFOCF₂CF(CF₃)OCF₂CF₂ or —CF₂CF₂—.

Embodiment crosslinkable polymers are:

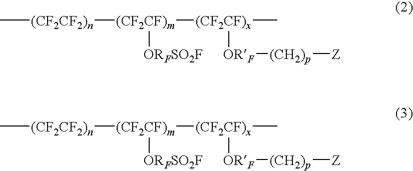

wherein R_{F} and R′_{F} are independently linear or branched perfluoroalkylene groups of 1 to 20 carbon atoms, optionally containing oxygen or chlorine;
p is an integer from 0 to 1;
n, m, and x are the number of repeating units of the monomers; and

Z is selected from SO₂N₃, OCN and CN.

Similar partially fluorinated polymers of the following formula can be prepared. The corresponding sulfonyl fluoride monomers can be prepared as described in WO200077057:

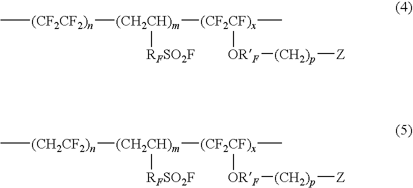

The crosslinkable monomer can be represented by the following formula:

F₂C═CF—OR′_{F}—(CH₂)ₚ—Z (6)

where Z is selected from SO₂N₃, OCN and CN; p can be 0 or 1, and R′_{F} is as described above.

Suitable representative crosslinkable monomers are:

F₂C═CF—OR′_{F}—CH₂—SO₂N₃ (7)

F₂C═CF—OR′_{F}—CH₂—OCN (8)

F₂C═CF—OR′_{F}—CH₂—CN (9)

wherein R′_{F} is as described above.

In an embodiment crosslinkable monomers having the —SO₃N₃ moiety can be prepared by reaction of the corresponding sulfonyl fluoride with NaN₃ according to U.S. Pat. No. 6,417,379 and U.S. Pat. No. 6,365,693, to E.I. du Pont de Nemours and Company, Wilmington, Del. The reaction is shown below:

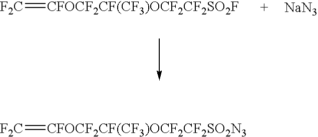

In another embodiment crosslinkable monomers having the —OCN moiety can be prepared by reaction of the corresponding fluorinated monomer having a terminal alcohol group with halogenated cyanide according to U.S. Pat. No. 6,300,445 to E.I. du Pont de Nemours and Company, Wilmington, Del. The reaction is shown below:

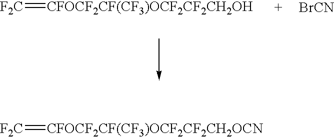

The reactions of short chain perfluoroalkane sulfonyl azides (R_{F}SO₂N₃) releasing SO₂ under radiation exposure and heating is known in the literature. See Tetrahedron Letters, Vol. 33, No 43, p 6503-9504, 1992. It is known that —CN groups are used to crosslink Kalrez® resins. It is known that RCH₂OCN can be trimerized above 180° C. and R_{F}CN can be trimerized under catalytic conditions.

The crosslinkable polymers of the present invention can be prepared by polymerizing F₂C═CF—OR′_{F}—(CH₂)ₚ—Z and CR′₂═CR′(O)_{q}R_{F}SO₂F with monomers selected from TFE (CF₂═CF₂), CH₂═CF₂, CH₂═CH₂, and mixtures thereof. The R′, R_{F}, R′_{F}, p and q are as described hereinabove. In an embodiment, the CR′₂═CR′(O)_{q}R_{F}SO₂F monomer is CF₂═C(F)OCF₂CF(CF₃)OCF₂ CF₂SO₂F.

In an embodiment, the process to prepare a crosslinkable polymer comprises polymerizing monomers CF₂═CF(O)_{q}R_{F}SO₂F and CF₂═CFOR′_{F}—(CH)ₚ—Z, and a monomer selected from CH₂═CF₂, TFE and mixtures thereof and a free radical polymerization initiator. The R_{F}, R′_{F}, p and q are as described hereinabove.

Suitable optional monomers include but are not limited to hexafluoropropylene, perfluoro(methyl vinyl ether), perfluoro(propyl vinyl ether), methyl vinyl ether, chlorotrifluoroethylene, perfluoro(2,2-dimethyl-1,3-dioxole), and propylene. Any of these comonomers may be optionally substituted, such as substitution with one or more SO₂F groups.

The polymerization of the monomers may be done neat in solution or organic suspension. The polymerization may be done in batch, semibatch or continuous operations. A free radical polymerization initiator is typically used, such as but not limited to peroxides such as perfluoro(propionyl peroxide) (3P), azonitriles such as azobis(isobutylronitrile) (AIBN), and redox initiators such as persulfate-bisulfite. In the case of dispersion polymerizations a surfactant can also be used, typically a partially fluorinated or perfluorinated surfactant. The surfactant can be anionic, cationic, or nonionic. Suitable surfactants include, are not limited to alkyl benzene sulfonates, and fluorinated surfactants such as C8 (ammonium perfluorooctanoate), Zonyl® fluorosurfactants such as Zonyl® 62, Zonyl® TBS, Zonyl® FSP, Zonyl®FS-62, Zonyl® FSA, Zonyl® FSH, and fluorinated alkyl ammonium salts such as but not limited to R′_{w}NH(_{4-w})X wherein X is Cl⁻, Br⁻, I⁻, F⁻, HSO₄⁻, or H₂PO₄⁻, where w=0-4, where R′ is (R_{F}CH₂CH₂). Zonyl® fluorosurfactants are available from E.I. DuPont de Nemours, Wilmington, Del., and in general are anionic, cationic, amphoteric or nonionic oligomeric hydrocarbons containing ether linkages and fluorinated substituents.

The polymerizations can be performed at any temperature at which the reaction proceeds at a reasonable rate and does not lead to degradation of the product or monomers. The process is generally run at a temperature at which the selected initiator generates free radicals. The reaction time is dependent upon the reaction temperature, the amount of initiator and the concentration of the reactants, and is usually about 1 hour to about 100 hours.

In an embodiment, the CF₂═CFOCF₂CF(CF₃)OCF₂CF₂SO₂F (PSEPVE), and crosslinkable monomer comprised of the formula F₂C═CF—OR′_{F}—(CH₂)ₚ—Z can be polymerized with TFE and/or CH₂═CF₂ by solution polymerization. Typical free radical initiators such as Lupersol 11 and perfluoroacyl peroxide can be used in suspension polymerization. A preferred process is solution polymerization using fluorocarbon solvents. Suitable solvents known in the art can be used and examples include, but are not limited to fluorocarbons and perfluorocarbons. Suitable solvents and free radical initiators are described in U.S. Pat. No. 3,282,875 to E.I. du Pont de Nemours and Company, Wilmington, Del.

In an embodiment, a reactor can be precharged with PSEPVE, a crosslinkable monomer of the formula F₂C═CF—OR′_{F}—(CH₂)ₚ—Z, and a portion of the free radical initiator. Pressure of the reactor can be built up by charging a portion of the TFE monomer. After the initial polymerization reaction as observed by about a 2-5 psi pressure drop, TFE and rest of the initiator can be added to the reaction over a period of 1 to 4 hours, while maintaining the pressure of the system.

The polymers can be recovered according to conventional techniques including filtration and precipitation using a non-solvent. They also can be dissolved or dispersed in a suitable solvent for further processing. In an embodiment the recovered polymers can be isolated by evaporation of solvent. The isolated polymers can be washed with alcohol such methanol and dried in an oven.

Crosslinking reactions of the crosslinkable polymers of formulae (1)-(5) and (10) are typically performed by heating the polymers which are in membrane form or in powder form. The membranes can be cast from solution. The heating time, conditions and the amount of crosslinkable monomer can be adjusted to obtain desirable controlled crosslinking. Such controlled crosslinking can give slightly crosslinked polymers that can impart mechanical properties required of commercial membranes and can reduce excess liquid or water uptake.

One suitable crosslinking method comprises exposing the polymer to radiation, such as but not limited to ultraviolet radiation, gamma ray radiation, electron beam radiation and heavy ion radiation initiating the formation of crosslinks. Any suitable apparatus can be used. Typically electron beam radiation is used at a dosage of 10-100 kGy.

In an embodiment, the polymers from formulae (1)-(5) are pressed into membranes at a temperature below 150° C. which is the decomposition temperature of the crosslinkable Z moiety. These membranes can be further heated at temperatures above 150° C. to initiate crosslinking reactions of the polymers. In an embodiment, when the crosslinkable Z moiety is —SO₂N₃, ultraviolet radiation can be used to initiate crosslinking reactions in addition to heating. In another embodiment UV radiation can be used initiate crosslinking reactions.

Hydrolysis of the crosslinked polymers obtained by crosslinking of the crosslinkable polymers of formulae (1)-(5) can be with alkali metal bases such as KOH, NaOH, LiOH or alkali metal carbonates such as Na₂CO₃, Li₂CO₃, K₂CO₃ in solvents such as methanol, DMSO and water. The hydrolysis step is usually carried out from room temperature to about 100° C., preferably from room temperature to about 50° C. After the hydrolysis step, R_{F}SO₃M groups are formed by the hydrolysis of R_{F}SO₂F groups in crosslinked polymers of formulae (1)-(5), where M is independently H, an alkali cation, ammonium or substituted ammonium groups. M can be a single cation or a mixture of different cations selected from the group consisting of H, Cs, K, Na, and Li.

The hydrolysis of the crosslinkable polymers of formulae (1)-(5) can be performed without crosslinking. The conditions can be as described for the hydrolysis of the crosslinked polymers. Typically the hydrolysis step is performed after the crosslinkable polymer is crosslinked and formed into a proton conductive membrane. The crosslinking and the hydrolysis may be done simultaneously.

In an embodiment, the hydrolyzed polymer containing the R_{F}SO₃M obtained from the hydrolysis of corresponding R_{F}SO₂F is as shown below:

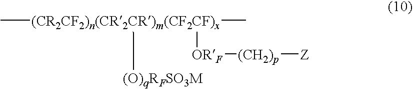

wherein R_{F} and R′_{F} are independently linear or branched perfluoroalkyl groups of 1 to 20 carbon atoms, optionally containing oxygen or chlorine;

p and q are independently integers from 0 to 1;
R and R′ are independently H or F, with the proviso that when R′ is F then q is 1;
n, m, and x are the number of repeating units of the monomers;
Z is selected from SO₂N₃, OCN and CN; and

M is independently H, an alkali cation, ammonium or substituted ammonium groups.

In an embodiment the crosslinkable polymer from formula (10) can be crosslinked to obtain a proton conductive membrane.

The polymers described herein can be formed into proton conductive membranes using any conventional method such as but not limited to solution or dispersion film casting or extrusion techniques. The membrane thickness can be varied as desired for a particular application. Typically, for electrochemical uses, the membrane thickness is less than about 350 μm, more typically in the range of about 15 μm to about 175 μm. If desired, the membrane can be a laminate of two polymers such as two polymers having different equivalent weight. Such films can be made by laminating two membranes. Alternatively, one or both of the laminate components can be cast from solution or dispersion. When the membrane is a laminate, the chemical identities of the monomer units in the additional polymer can independently be the same as or different from the identities of the analogous monomer units of the first polymer. In an embodiment the membrane is crosslinked after the lamination step. The membrane may optionally include a porous support or reinforcement for the purposes of improving mechanical properties, for decreasing cost and/or other reasons. For resistance to thermal and chemical degradation, the support typically is made from a fluoropolymer, more typically a perfluoropolymer. For example, the perfluoropolymer of the porous support can be a microporous film of polytetrafluoroethylene (PTFE) or a copolymer of tetrafluoroethylene. Microporous PTFE films and sheeting are known that are suitable for use as a support layer. For example, U.S. Pat. No. 3,664,915 discloses uniaxially stretched film having at least 40% voids. U.S. Pat. Nos. 3,953,566, 3,962,153 and 4,187,390 disclose porous PTFE films having at least 70% voids. Impregnation of expanded PTFE (ePTFE) with perfluorinated sulfonic acid polymer is disclosed in U.S. Pat. Nos. 5,547,551 and 6,110,333. ePTFE is available under the trade name “Goretex” from W. L. Gore and Associates, Inc., Elkton, Md., and under the trade name “Tetratex” from Tetratec, Feasterville, Pa. The crosslinking of the membrane can be performed after the porous support is impregnated with the crosslinkable polymer. One of ordinary skill in the art will understand that membranes prepared from the dispersions may have utility in packaging, in non-electrochemical membrane applications, as an adhesive or other functional layer in a multi-layer film or sheet structure, and other classic applications for polymer films and sheets that are outside the field of electrochemistry.

Membrane electrode assemblies (MEA) and fuel cells therefrom are well known in the art and can comprise any of the proton conductive membranes described above. One suitable embodiment is described herein. A proton conductive membrane is used to form a MEA by combining it with a catalyst layer, comprising a catalyst such as platinum, which is unsupported or supported on carbon particles, a binder such as Nafion®, and a gas diffusion backing. The catalyst layers may be made from well-known electrically conductive, catalytically active particles or materials and may be made by methods well known in the art. The catalyst layer may be formed as a film of a polymer that serves as a binder for the catalyst particles. The binder polymer can be a hydrophobic polymer, a hydrophilic polymer, or a mixture of such polymers. The binder polymer is typically ionomeric and can be the same ionomer as in the membrane. A fuel cell is constructed from a single MEA or multiple MEAs stacked in series by further providing porous and electrically conductive anode and cathode gas diffusion backings, gaskets for sealing the edge of the MEA(s), which also provide an electrically insulating layer, graphite current collector blocks with flow fields for gas distribution, aluminum end blocks with tie rods to hold the fuel cell together, an anode inlet and outlet for fuel such as hydrogen or methanol, and a cathode gas inlet and outlet for oxidant such as air.

The in-plane conductivity of proton conductive membranes can be measured under conditions of controlled relative humidity and temperature by a technique in which the current flows parallel to the plane of the membrane. A four-electrode technique can used similar to that described in an article entitled “Proton Conductivity of Nafion® 117 As Measured by a Four-Electrode AC Impedance Method” by Y. Sone et al., J. Electrochem. Soc. 143, 1254 (1996) that is herein incorporated by reference. A lower fixture can be machined from annealed glass-fiber reinforced Poly Ether Ether Ketone (PEEK) to have four parallel ridges containing grooves that supported and held four 0.25 mm diameter platinum wire electrodes. The distance between the two outer electrodes can be 25 mm, while the distance between the two inner electrodes can be 10 mm. A strip of proton conductive membrane can be cut to a width between 10 and 15 mm and a length sufficient to cover and extend slightly beyond the outer electrodes, and placed on top of the platinum electrodes. An upper fixture which has ridges corresponding in position to those of the bottom fixture, can be placed on top and the two fixtures were clamped together so as to push the proton conductive membrane into contact with the platinum electrodes. The fixture containing the membrane can be placed inside a small pressure vessel (pressure filter housing), which can be placed inside a forced-convection thermostated oven for heating. The temperature within the vessel can be measured by means of a thermocouple. Water can be fed from a calibrated Waters 515 HPLC pump (Waters Corporation, Milford, Mass.) and combined with dry air fed from a calibrated mass flow controller (200 sccm maximum) to evaporate the water within a coil of 1.6 mm diameter stainless steel tubing inside the oven. The resulting humidified air can be fed into the inlet of the pressure vessel. The total pressure within the vessel (100 to 345 kPa) can be adjusted by means of a pressure-control letdown valve on the outlet and measured using a capacitance manometer (Model 280E, Setra Systems, Inc., Boxborough, Mass.). The relative humidity can be calculated assuming ideal gas behavior using tables of the vapor pressure of liquid water as a function of temperature, the gas composition from the two flow rates, the vessel temperature, and the total pressure. The slots in the lower and upper parts of the fixture allowed access of humidified air to the membrane for rapid equilibration with water vapor. Current can be applied between the outer two electrodes while the resultant voltage can be measured between the inner two electrodes. The real part of the AC impedance (resistance) between the inner two electrodes, R, can be measured at a frequency of 1 kHz using a potentiostat/frequency response analyzer (PC4/750™ with EIS software, Gamry Instruments, Warminster, Pa.). The conductivity, K, of the membrane can be then calculated as

κ=1.00cm/(R×t×w),

where t is the thickness of the membrane and w is its width (both in cm).

### Example 1

In a stainless steel pressure vessel the following materials were added: 50 g of CF₂═CFOCF₂CF(CF₃)OCF₂CF₂SO₂F, 5 g of CF₂═CFOCF₂CF(CF₃)OCF₂CF₂CH₂OCN, 0.8 g of Percadox in 100 ml of F113 (1,1,2-trichloro-1,2,2-trifluoroethane). The vessel was sealed, cooled to 0° C., and purged three times with nitrogen. Next, 90 g of CF₂═CH₂ is added. The vessel was slowly heated to 60° C. and held at that temperature for 10 hours. After cooling, the resulting polymer mixture was washed, and 104.4 g of polymer was obtained.

A membrane was prepared by pressing the obtained polymer at 160-170° C. IR spectra indicate the presence of —OCN groups.

### Example 2

In a stainless steel pressure vessel the following materials were added: 246 g of CF₂═CFOCF₂CF(CF₃)OCF₂CF₂SO₂F, 45 g of CF₂═CFOCF₂CF(CF₃)OCF₂CF₂SO₂N₃, 0.15 g of HFPO (hexafluoropropylene oxide) dimer peroxide [CF₃CF₂CF₂OCF(CF₃)(C═O)OO(C═O)CF(CF₃)OCF₂CF₂CF₃] in 420 g of CF₃CF₂CF₂OCF(CF₃)CF₂OCHFCF₃ solvent. The vessel was sealed, cooled to 0° C., and purged three times with nitrogen. Next, 33 g of CF₂═CF₂ is added. The vessel was slowly heated to room temperature, between 23-27° C., and held at that temperature for 90 minutes. After cooling, the resulting polymer mixture was evaporated to remove all liquid present, washed with methanol, and then frozen in liquid nitrogen. The frozen polymer was cut in a high speed blender to give a granular polymer, which was vacuum dried at 80-100° C. for 3 hours, resulting in 79.4 g of polymer.

### Example 3

A polymer was prepared as described in Example 2 and pressed thermally into a film, at 160° C. The crosslinking was completed by pressing at 20,000 psi at 180° C. for 20 minutes. A transparent film was obtained. The film was immersed in a solution of KOH, 5 ml methanol, 5 ml water and 20 ml of DMSO at 75° C. for 2 hours. The film was removed and washed with water, then acidified with 8% HNO₃ at room temperature. IR analysis indicated that no SO₂F remained.

Analysis of the polymer was: C 20.70%, F 63.60%, N 1.18%, and S 3.81%.

For the following examples, membrane resistance and conductivity were measured through-plane under controlled temperature and relative humidity conditions as described in WO2008127320.

### Example 4

To a stainless steel pressure vessel 505 g of PFSVE (CF₂═CFOCF₂CF₂SO₂F) and 95 g of 8-SAVE (CF₂═CFOCF₂CF(CF₃)OCF₂CF₂SO₂N₃) were added. The vessel was heated to 45° C., nitrogen was introduced at 100 psig, stirred at 500 rpm for 30 seconds, and then nitrogen was slowly vented to obtain a pressure of 3 psig. This nitrogen pressurization, stir, vent cycle was repeated two more times. TFE was introduced until a pressure of 25 psig was obtained and TFE was vented to obtain a pressure of 3 psig. This TFE pressurization/venting cycle was repeated three additional times. With stirring at 500 rpm, TFE pressure was adjusted to 85 psig and further additions were made to hold the pressure constant during 240 minutes of polymerization. An initial amount (12 ml) of cooled 4 wt % solution of HFPO dimer peroxide (DP) initiator in low molecular weight fluoroether was introduced to the reactor. At 19 minutes after the initial DP addition, further initiator solution was introduced at a constant rate of 0.58 ml/min during the next 200 minutes of polymerization. At 21 minutes after stopping the DP addition, the TFE addition was stopped, and the vessel was cooled. A mixture of polymer, unused monomers, and the low molecular weight fluoroether were removed from the pressure vessel to obtain 788 g of reaction mixture.

To a 155 g portion of the above reaction mixture present in a plastic bottle, 310 g of methylene chloride was added to precipitate the polymer to form a slurry. This polymer slurry was mixed/ground using a Tekmar Tissumizer type SDT-1810, and was allowed to stand for 10 minutes, and polymer was recovered by filtration. Another 155 g portion of methylene chloride was added to the polymer, followed by mixing, and then filtration was repeated. This extraction cycle was repeated three times. After drying the polymer at ambient temperature in a chemical fume hood for 2 hrs, the polymer was further dried under vacuum at ambient temperature for 40 hrs. 31.2 g of polymer was recovered. ¹⁹F-NMR analysis of the copolymer dissolved in hexafluorobenzene indicated a molar composition of 73.5% TFE, 22.5% PFSVE, and 4.0% 8-SAVE.

Films with 6-7 μm dry film thickness were cast from 10% solutions of the copolymer in hexafluorobenzene. These films were cured for 10 minutes in a convection oven at temperatures indicated in Table 1 and were examined using FTIR. The intense absorption of the R_{F}SO₂F at 1468 cm⁻¹ remained after the curing. The absorbance of the peaks associated with —R_{F}SO₂N₃ at 2151 cm⁻¹ and of fluoro ether at 986 cm⁻¹ were measured. The absorbance ratio A₂₁₅₁/A₉₈₆, was used to normalize the sulfonylazide absorbance for variations in film thickness. When further divided by the absorbance ratio of 0.6185 obtained for an uncured film of sample 4E, the value obtained served as a measure of the remaining fraction of sulfonylazide.

TABLE 1

| | | Absorbance | | | |
|---|---|---|---|---|---|
| | | 2151 cm⁻¹ | Absorbance | Fraction | |
| | Temperature | SO₂N₃ | 986 cm⁻¹ | Azide | |
| Sample | ° C. | peak | ether peak | remaining | k min⁻¹ |
| 4A | 180 | <0.001 | 0.58 | 0.000 | |
| 4B | 170 | 0.014 | 0.684 | 0.033 | 0.3408 |
| 4C | 160 | 0.096 | 0.539 | 0.288 | 0.1245 |
| 4D | 150 | 0.217 | 0.544 | 0.645 | 0.0439 |
| 4E | 23 | 0.394 | 0.637 | 1.000 | |

Rate constant k for first-order decomposition of sulfonylazide group of samples 4B-4D were calculated from the equation below:

$$k = \frac{ln ( fraction of azide remaining )}{10 min}$$

The rate constants obtained were fitted to the Arrhenius equation in the form:

$$k = A {e}^{\frac{- {E}_{a}}{RT}}$$

where T is the absolute temperature (K), R is the gas constant, A=2.35×10¹⁸ and Eₐ=160 kJ/mole.

A copolymer film which had been cured at 170° C. for 10 minutes was weighed and then swollen in hexafluorobenzene at ambient temperature for 30 minutes. The film was removed from the solvent, excess solvent blotted away, reweighed, and the weight gain was 6.0 wt %. This curing was effective in transforming a copolymer soluble in hexafluorobenzene to one in which the swelling was limited to 6 wt % uptake of solvent.

A 12 wt % solution of the copolymer in hexafluorobenzene was cast using a doctor blade with 30 mil gate height onto a Mylar® substrate to obtain films having ˜55 μm dry film thickness. This film was folded over on itself four times to give a ˜2 cm×4 cm×0.022 cm thick stack, and was then pressed in a hot press with 5000 lb force at 120° C. for 10 minutes. Only a very small amount of curing of the film occurred under these time-temperature conditions. The resulting pressed films showed no distinction of the four layers, with the layers being fused together; the creases were smooth indicating some melt flow. Another film was cured at 170° C. for 10 minutes, then folded over to make a four-layer-thick stack, and then subjected to the same hot pressing conditions. After hot pressing, the four layers could still be peeled apart, and the creases were not smoothened out by hot pressing. This indicated that the curing was effective in eliminating or greatly reducing the melt flow of the copolymer.

### Example 5

Reinforced membrane was prepared as described below. A section of ePTFE (1.5 mil thick, 16 g/m² basis weight) substrate with one of its edges taped to one end of a vacuum plate was placed in a chemical fume hood. A smaller section of silicone-treated release Mylar® substrate was also taped to the center of the plate, leaving some of the holes in the vacuum plate uncovered around the perimeter of the Mylar® substrate. A 12 wt % hexafluorobenzene solution of copolymer from Example 4 was cast using a doctor blade with 30 mil gate height onto the Mylar® substrate. The ePTFE substrate was embedded in the wet coating of the copolymer, and held down by the vacuum holes outside of the Mylar® substrate. A second coating of polymer solution was made over the top of the expanded PTFE. The vacuum plate was placed into a box purged with dry nitrogen and allowed to dry at ambient temperature. The resulting membrane was peeled from the Mylar® substrate, and cured in a convection oven at 170° C. for 10 minutes to give a reinforced membrane of 45 μm thickness. This reinforced membrane was hydrolyzed in 10:20:70 KOH:DMSO:H₂O at 80° C. for 4 hours to convert the —R_{F}SO₂F groups to —R_{F}SO₃K groups; rinsed in deionized water, and was then acid exchanged in a 14% nitric acid solution at ambient temperature for a period of 1 h. The ion-exchanged membrane was soaked in deionized excess water at ambient temperature for 30 minutes, and the soaking was repeated two more times with fresh deionized water. Through-plane conductivity of the reinforced membrane was 14.6, 44, and 110 mS/cm at 80° C. when measured at relative humidities of 25, 50, and 95%, respectively.

### Example 6

To a stainless steel pressure vessel 420 g of PFSVE and 180 g of 8-SAVE were added. The vessel was heated to 45° C., nitrogen was introduced at 100 psig, stirred at 500 rpm for 30 s, and then the nitrogen was slowly vented to 3 psig. This nitrogen pressurization, stir, vent cycle was repeated two more times. TFE was introduced to a pressure of 25 psig and then vented to 3 psig. This TFE pressurization/venting cycle was repeated three additional times. With stirring at 500 rpm, TFE pressure was adjusted to 80 psig and further additions were made to hold the pressure of the vessel constant during 196 minutes of polymerization. An initial amount of 15.1 ml of a cooled 5.8 wt % solution of HFPO dimer peroxide (DP) initiator in Freon® E2 was added to the reactor. After 17 minutes of the initial DP initiator addition, further additions of the initiator solution was made at a constant rate of 0.74 ml/min during the next 156 minutes of polymerization. At 23 minutes after stopping the DP addition, the TFE addition was stopped and the pressure vessel was cooled. A mixture of polymer, unused monomers, and E2 were removed to obtain 805 g of product. The polymer was isolated as described in Example 4. ¹⁹F-NMR analysis of the copolymer dissolved in hexafluorobenzene indicated a molar composition of 74.5% TFE, 17.8% PFSVE, and 7.7% 8-SAVE.

A reinforced membrane was made from this copolymer as described in Example 5, with casting the membrane with 15 wt % hexafluorobenzene solution of copolymer and the membrane was cured at 170° C. for 20 minutes. Through-plane conductivity of the reinforced membrane was 11.9, 45, and 144 mS/cm at 80° C. when measured at relative humidities of 25, 50, and 95%, respectively.

What is claimed is:

1. A crosslinkable polymer having repeating units as shown in the following formula: 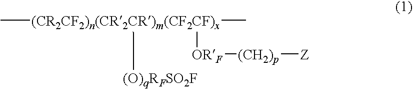
wherein R_{F} and R′_{F} are independently linear or branched perfluoroalkylene groups of 1 to 20 carbon atoms, optionally containing oxygen or chlorine;
p and q are independently integers from 0 to 1;
R and R′ are independently H or F, with the proviso that when R′ is F then q is 1;
n, m, and x are the number of repeating units of the monomers; and
Z is selected from SO₂N₃, OCN and CN.

2. The crosslinkable polymer of claim 1 wherein R′ is F.

3. The crosslinkable polymer of claim 1 wherein R is H

4. The crosslinkable polymer of claim 1 where R′ is F, q is 1, and R_{F} and R′_{F} are independently —CF₂CF(CF₃)OCF₂CF₂— or —CF₂CF₂—.

5. The crosslinkable polymer of claim 1 further comprising one or more repeating units derived from a comonomer selected from the group consisting of optionally substituted hexafluoropropylene, perfluoro(methyl vinyl ether), perfluoro(propyl vinyl ether), methyl vinyl ether, chlorotrifluoroethylene, perfluoro(2,2-dimethyl-1,3-dioxole) and propylene.

6. A crosslinked polymer of claim 1 formed by the cleavage of the Z moieties to form crosslinks.

7. The crosslinked polymer of claim 1 wherein crosslinks are formed by dimerization or trimerization reactions of the Z moieties.

8. An ion conductive membrane formed from the crosslinkable polymer of claim 1 wherein the R_{F}SO₂F groups are converted by hydrolysis to R_{F}SO₃M groups, wherein M is independently H, an alkali cation, ammonium or substituted ammonium groups.

9. An electrochemical cell comprising the ion conductive membrane of claim 8.

10. The electrochemical cell of claim 9 that is a fuel cell.

11. A crosslinkable polymer having repeating units as shown in the following formula: 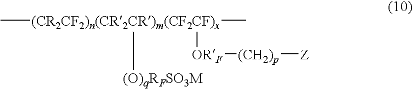
wherein R_{F} and R′_{F} are independently linear or branched perfluoroalkyl groups of 1 to 20 carbon atoms, optionally containing oxygen or chlorine;
p and q are independently integers from 0 to 1;
R and R′ are independently H or F, with the proviso that when R′ is F then q is 1;
n, m, and x are the number of repeating units of the monomers;
Z is selected from SO₂N₃, OCN and CN; and
M is independently H, an alkali cation, ammonium or substituted ammonium groups.

12. The crosslinkable polymer of claim 11 wherein R′ is F.

13. The crosslinkable polymer of claim 12 where R′ is F, q is 1, and R_{F} and R′_{F} are independently —CF₂CF(CF₃)OCF₂CF₂— or —CF₂CF₂—.

14. A process to prepare a crosslinkable polymer comprising:
polymerizing crosslinkable monomer CF₂═CFOR′_{F}—(CH)ₚ—Z and monomer CR′₂═CR′(O)_{q}R_{F}SO₂F with monomers selected from CF₂═CF₂, CH₂═CF₂ and mixtures thereof, with a free radical initiator;
wherein R, R′, R_{F}, R′_{F}, Z, p and q are as defined in claim 1.

15. A process to prepare a crosslinked polymer comprising:
(a) providing a crosslinkable polymer having repeating units as shown in the following formula: 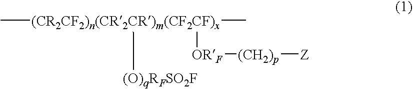
wherein R_{F} and R′_{F} are independently linear or branched perfluoroalkylene groups of 1 to 20 carbon atoms, optionally containing oxygen or chlorine;
p and q are independently integers from 0 to 1;
R and R′ are independently H or F, with the proviso that when R′ is F then q is 1;
n, m, and x are the number of repeating units of the monomers; and
Z is selected from SO₂N₃, OCN and CN;
and
(b) cleaving the Z moieties to form a crosslinked polymer.

16. A process to prepare a proton conductive membrane, comprising:
(a) providing a crosslinkable polymer of claim 1;
(b) forming the crosslinkable polymer into a membrane; and
(c) crosslinking and hydrolyzing the crosslinkable polymer.

17. The process of claim 16, wherein the crosslinking of the crosslinkable polymer is performed prior to hydrolysis of the crosslinkable polymer.

18. The process of claim 16, wherein the crosslinkable polymer is impregnated into a porous support prior to the crosslinking of the crosslinkable polymer.
